(19) United States
(12) Patent Application Publication
(10) Pub. No.: US 2016/0212782 A1
(43) Pub. Date: Jul. 21, 2016

(54) METHODS FOR EFFICIENT WIRELESS COMMUNICATIONS AND COMMUNICATIONS APPARATUS UTILIZING THE SAME

(71) Applicant: MediaTek Inc., Hsin-Chu (TW)

(72) Inventors: Cheng-Hsiao KO, Hsinchu City (TW); Ming-Wan HSU, Taipei City (TW); Chih-Kuang WU, Jhubei City (TW)

(21) Appl. No.: 14/991,339

(22) Filed: Jan. 8, 2016

Related U.S. Application Data
(60) Provisional application No. 62/103,720, filed on Jan. 15, 2015.

(51) Int. Cl. H04W 76/02; H04W 76/06; H04W 68/00

(52) U.S. Cl. CPC H04W 76/023; H04W 68/005; H04W 76/068

(57) ABSTRACT

A method for efficient wireless communications includes transmitting a tracking area update (TAU) request message by a communications apparatus to a peer device to initiate a TAU procedure; receiving a paging message by the communications apparatus from the peer device after transmitting the TAU request message; and in response to receipt of the paging message, retransmitting the TAU request message by the communications apparatus to the peer device to reinitiate the TAU procedure immediately or transmitting a request message by the communications apparatus to the peer device immediately, without waiting a predetermined time period.

### CROSS REFERENCE TO RELATED APPLICATIONS

This application claims the benefit of U.S. Provisional Application No. 62/103,720 filed 2015 Jan. 15 and entitled “Reduce MT CSFB latency when collision with TAU occurs”, the entire contents of which are hereby incorporated by reference.

### BACKGROUND OF THE INVENTION

1. Field of the Invention

The invention relates to methods for efficient wireless communications.

2. Description of the Related Art

The term “wireless” normally refers to an electrical or electronic operation, which is accomplished without the use of a “hard wired” connection. “Wireless communications” is the transfer of information over a distance without the use of electrical conductors or wires. The distances involved may be short (a few meters for television remote controls) or very long (thousands or even millions of kilometers for radio communications). The best known example of wireless communications is the cellular telephone. Cellular telephones use radio waves to enable an operator to make phone calls to another party, from many locations worldwide. They can be used anywhere, as long as there is a cellular telephone site to house equipment that can transmit and receive signals, which are processed to transfer both voice and data to and from the cellular telephones.

There are various well-developed and well-defined cellular communications technologies. For example, the Global System for Mobile communications (GSM) is a well-defined communications system in common use, which uses time division multiple access (TDMA) technology, which is a multiplex access scheme for digital radio, to send voice, data, and signalling data (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. The Wireless Fidelity (Wi-Fi) is a technology defined by the 802.11 engineering standard and can be used for home networks, mobile phones, video games, to provide a high-frequency wireless local area network. The Long-Term Evolution (LTE) is a standard for wireless communication of high-speed data for mobile phones and data terminals. It is based on the GSM/EDGE and UMTS/HSPA network technologies, increasing capacity and speed using a different radio interface together with core network improvements.

In order to provide more efficient communications services, methods for efficient wireless communications are provided.

### BRIEF SUMMARY OF THE INVENTION

Methods for efficient wireless communications and communications apparatuses are provided. An exemplary embodiment of a communications apparatus comprises a radio transceiver and a processor. The radio transceiver transmits or receives wireless radio frequency signals to or from a peer device. The processor transmits a tracking area update (TAU) request message to the peer device via the radio transceiver to initiate a TAU procedure, receives a paging message from the peer device after transmitting the TAU request message, and retransmits the TAU request message to the peer device to reinitiate the TAU procedure immediately, or it transmits a request message to the peer device immediately without waiting a predetermined time period.

An exemplary embodiment of a method for efficient wireless communications comprises transmitting a tracking area update (TAU) request message by a communications apparatus to a peer device to initiate a TAU procedure; receiving a paging message by the communications apparatus from the peer device after transmitting the TAU request message; and in response to receipt of the paging message, retransmitting the TAU request message by the communications apparatus to the peer device to reinitiate the TAU procedure immediately or transmitting a request message by the communications apparatus to the peer device immediately, without waiting a predetermined time period.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1A shows an exemplary block diagram of a communications apparatus according to an embodiment of the invention;

FIG. 1B shows an exemplary block diagram of a communications apparatus according to another embodiment of the invention;

FIG. 2 shows an exemplary block diagram of a modem according to an embodiment of the invention;

FIG. 3 shows an exemplary message flow of a TAU procedure from the viewpoint of a communications apparatus;

FIG. 4 shows a complete message flow of a TAU procedure in the TAU phase;

FIG. 5 shows an exemplary flow chart of a method for efficient wireless communications according to an embodiment of the invention;

FIG. 6A shows a conventional flow chart for handling a paging message received after the T3411 timer has been started;

FIG. 6B shows a flow chart for handling a paging message received after the T3411 timer has been started according to a first embodiment of the invention;

FIG. 6C shows an exemplary flow chart of a method for efficient wireless communications according to the first embodiment of the invention;

FIG. 7A shows a conventional flow chart for handling a paging message received during the TAU procedure;

FIG. 7B shows a flow chart for handling a paging message received during the TAU procedure according to a second embodiment of the invention;

FIG. 7C shows an exemplary flow chart of a method for efficient wireless communications according to the second embodiment of the invention;

FIG. 8A shows a conventional flow chart for handling a paging message received after the T3440 timer has been started;

FIG. 8B shows a flow chart for handling a paging message received after the T3440 timer has been started according to a third embodiment of the invention; and

FIG. 8C shows an exemplary flow chart of a method for efficient wireless communications according to the third embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

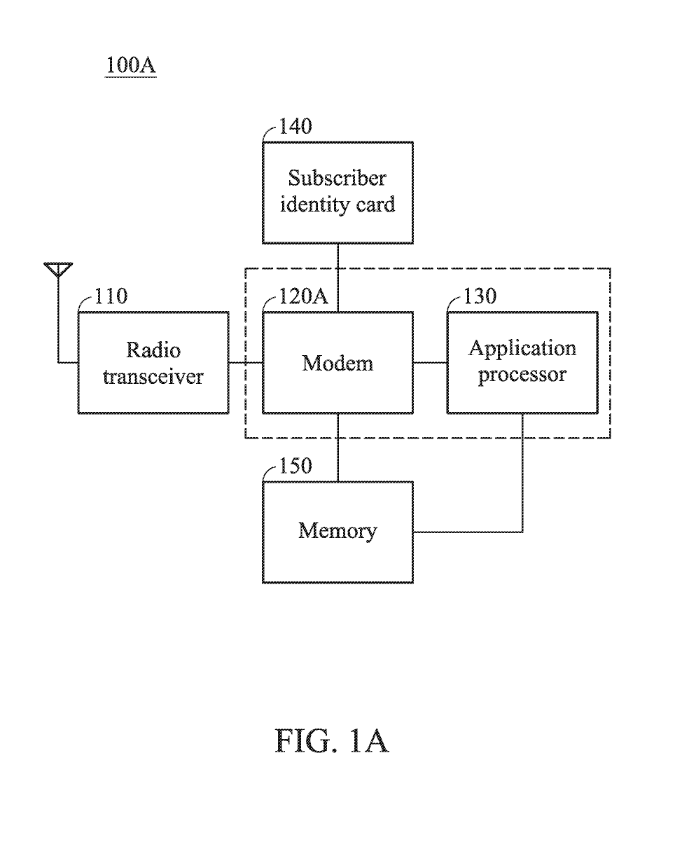

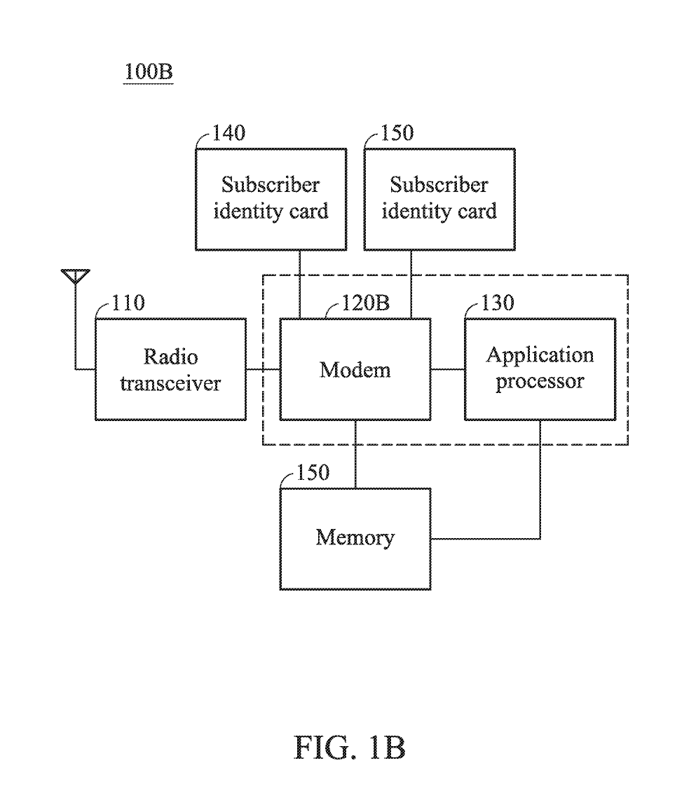

FIG. 1A shows an exemplary block diagram of a communications apparatus according to an embodiment of the invention. The communications apparatus 100A may be a portable electronic device, such as a mobile station (MS, which may be interchangeably referred to as user equipment (UE)). The communications apparatus 100A may comprise at least an antenna module comprising at least one antenna, a radio transceiver 110, a modem 120A, an application processor 130, a subscriber identity card 140, and a memory 150. The radio transceiver 110 may receive wireless radio frequency signals via the antenna module, transmit wireless radio frequency signals via the antenna module and perform RF signal processing. For example, the radio transceiver 110 may convert the received signals to intermediate frequency (IF) or baseband signals to be processed, or receive the IF or baseband signals from the modem 120A and convert the received signals to wireless radio frequency signals to be transmitted to a peer device. According to an embodiment of the invention, the peer device may be a cell, an evolved node B, a base station, etc., at the network side and communicating with the communications apparatus 100A via the wireless radio frequency signals.

The radio transceiver 110 may comprise a plurality of hardware devices to perform radio frequency conversion and RF signal processing. For example, the radio transceiver 110 may comprise a power amplifier for amplifying the RF signals, a filter for filtering unwanted portion in the RF signals and/or a mixer for performing radio frequency conversion. According to an embodiment of the invention, the radio frequency may be, for example, 900 MHz or 1800 MHz for a global system for mobile communication (GSM), or 1900 MHz for a Universal Mobile Telecommunications System (UMTS), or the frequency of any specific frequency band for a Long-Term Evolution (LTE) system, etc.

The modem 120A may be a cellular communications modem configured for handling cellular system communications protocol operations and processing the IF or baseband signals received from or to be transmitted to the radio transceiver 110. The application processor 130 is configured for running the operating system of the communications apparatus 100A and running application programs installed in the communications apparatus 100A. In the embodiments of the invention, the modem 120A and the application processor 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a SIM, USIM, R-UIM or CSIM card, or the like, and it typically contains user account information, an international mobile subscriber identity (IMSI), and a set of SIM application toolkit (SAT) commands. It may provide storage space for phone book contacts. The memory 150 may be coupled to the modem 120A and application processor 130 and may store system data or user data.

FIG. 1A shows a single-card single-standby application. With advancements in communications techniques, the communications apparatuses are now capable of supporting multi-card multi-standby application and handling multi-RAT's (radio access technology's) operations, such as at least two of GSM/GPRS/EDGE (Global System for Mobile Communications/General Packet Radio Service/Enhanced Data rates for Global Evolution), WCDMA (Wideband Code Division Multiple Access), cdma2000, WiMAX (Worldwide Interoperability for Microwave Access), TD-SCDMA (Time Division Synchronous Code Division Multiple Access), LTE (Long Term Evolution), and TD-LTE (Time Division Long Term Evolution) RATs, or the like, via one communications apparatus.

FIG. 1B shows an exemplary block diagram of a communications apparatus according to another embodiment of the invention. Most of the elements shown in FIG. 1B are similar to FIG. 1A, and thus the descriptions are omitted here for brevity. In this embodiment, the communications apparatus 100B may comprise multiple subscriber identity cards 140 and 150 coupled to the modem 120B, thereby the modem 120B may at least support two RAT communications, wherein the two RATs may be different RATs or the same RAT, and the invention should not be limited to either case.

According to an embodiment of the invention, the modem 120B, the radio transceiver 110 and/or the antenna module may be shared by subscriber identity cards 140 and 150 to support at least two RAT communications. Therefore, in this embodiment, the communications apparatus 100B may be regarded as comprising at least two communications units, one may at least comprise the subscriber identity card 140, (all or part of) the modem 120B, the radio transceiver 110 and the antenna module, and the other may at least comprise the subscriber identity card 150, (all or part of) the modem 120B, the radio transceiver 110 and the antenna module.

According to an embodiment of the invention, the modem 120B may have the capability of handling the operations of multiple cellular system communications protocols and processing the IF or baseband signals for the corresponding communications units. Each communications unit may operate independently at the same time in compliance with a corresponding communications protocol, and thereby the communications apparatus 100B can support a multi-card multi-standby application.

Note that, in order to clarify the concept of the invention, FIG. 1A and FIG. 1B present simplified block diagrams in which only the elements relevant to the invention are shown. For example, in some embodiments of the invention, the communications apparatus may further comprise some peripheral devices not shown in FIG. 1A and FIG. 1B. In another example, in some embodiments of the invention, the communications apparatus may further comprise a central controller coupled to the modem 120A/120B and the application processor 130. Therefore, the invention should not be limited to what is shown in FIG. 1A and FIG. 1B.

Note further that subscriber identity cards 140 and 150 may be dedicated hardware cards as described above, or in some embodiments of the invention, may be individual identifiers, numbers, addresses, or the like which are burned in the internal memory device of the corresponding modem and are capable of identifying the individual communications entity that the corresponding communications unit operates. Therefore, the invention should not be limited to what is shown in the figures.

Note further that although communications apparatuses 100B shown in FIG. 1B support two RAT wireless communications services, the invention should not be limited thereto. Those who are skilled in this technology can still make various alterations and modifications based on the descriptions given above to derive the communications apparatuses capable of supporting more than two RAT wireless communications without departing from the scope and spirit of this invention.

Note further that, although in FIG. 1B, the radio transceiver 110 and the antenna module are shared by multiple communications units, the invention should not be limited thereto. Those who are skilled in this technology can still make various alterations and modifications based on the descriptions given above to derive the communications apparatuses comprising multiple radio transceivers and/or multiple antenna modules for supporting multiple RAT wireless communications without departing from the scope and spirit of this invention.

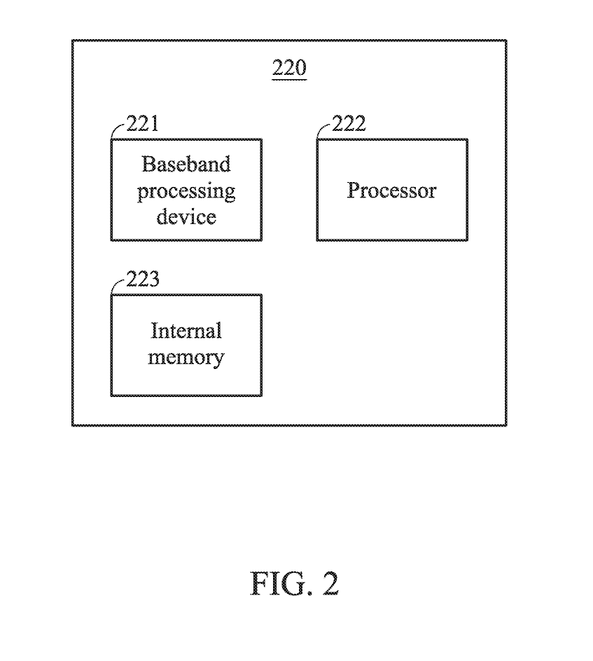

FIG. 2 shows an exemplary block diagram of a modem according to an embodiment of the invention. The modem 220 may be the modem 120A or 120B shown in FIG. 1A and FIG. 1B and may comprise at least a baseband processing device 221, a processor 222 and an internal memory 223. The baseband processing device 221 may receive the IF or baseband signals from the radio transceiver 110 and perform IF or baseband signal processing. For example, the baseband processing device 221 may convert the IF or baseband signals to a plurality of digital signals, and process the digital signals, and vice versa. The baseband processing device 221 may comprise a plurality of hardware devices to perform signal processing, such as an analog-to-digital converter for ADC conversion, a digital-to-analog converter for DAC conversion, an amplifier for gain adjustment, a modulator for signal modulation, a demodulator for signal demodulation, an encoder for signal encoding, a decoder for signal decoding, and so on.

The processor 222 may control the operations of the modem 220. According to an embodiment of the invention, the processor 222 may be arranged to execute the program codes of the corresponding software module of the modem 220. The processor 222 may maintain and execute the individual tasks, threads, and/or protocol stacks for different software modules. In a preferred embodiment, a protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

The processor 222 may read data from the subscriber identity card coupled to the modem, such as the subscriber identity card 140 and/or 150, and write data to the subscriber identity card. The internal memory 223 may store system data and user data for the modem 220. The processor 222 may also access the internal memory 223.

Note that in order to clarify the concept of the invention, FIG. 2 present simplified block diagrams in which only the elements relevant to the invention are shown. Therefore, the invention should not be limited to what is shown in FIG. 2.

Note further that in some embodiments of the invention, the modem may comprise more than one processor and/or more than one baseband processing device. For example, the modem may comprise multiple processors and/or multiple baseband processing devices for supporting multi-RAT operations. Therefore, the invention should not be limited to what is shown in FIG. 2.

According to an embodiment of the invention, the communications apparatus (e.g. the communications apparatus 100A or 100B) may communicate with a peer device (e.g. a cell, an evolved node B, a base station, etc.) by transmitting and receiving a plurality of wireless radio frequency signals. In an example, for the single-card single-standby application as shown in FIG. 1A, the communications apparatus 100A may communicate with a peer device in compliance with a corresponding communications protocol. To be more specific, the communications apparatus 100A may communicate with a peer device before camping on the peer device. The communications apparatus 100A may also perform a predetermined procedure to camp on the peer device, and keep communicating with the peer device after camping on the peer device. The procedure to camp on a peer device (for example, a cell, a base station, an evolved node B, etc., at the network side) is well-known in the art, and is omitted here for brevity.

In another example, for the multi-card multi-standby application as shown in FIG. 1B, each communications unit comprised in the communications apparatus 100B may communicate with a corresponding peer device in compliance with a corresponding communications protocol. To be more specific, each communications unit comprised in the communications apparatus 100B may communicate with a corresponding peer device before camping on the corresponding peer device. Each communications unit comprised in the communications apparatus 100B may also perform a predetermined procedure to camp on the corresponding peer device, and keep communicating with the corresponding peer device after camping on the corresponding peer device.

After camping on a corresponding peer device, the communications apparatus (or, the corresponding communications unit, hereinafter using the term communications apparatus for brevity) may operate in an IDLE mode and listen to the possible paging from the network.

The network knows the location of a communications apparatus that is roaming within the network. This makes it possible for the subscriber (that is, the user of the communications apparatus) to receive a call wherever it is. To keep the network up to date with the subscriber's location, the communications apparatus performs location updating. The location of a communications apparatus in IDLE mode is maintained on a Tracking Area (TA) List level. When a communications apparatus in IDLE mode moves into a cell that belongs to a TA different from the one(s) it is currently registered with, it performs a Tracking Area Update (TAU). The cell tracking area is broadcast in System Information.

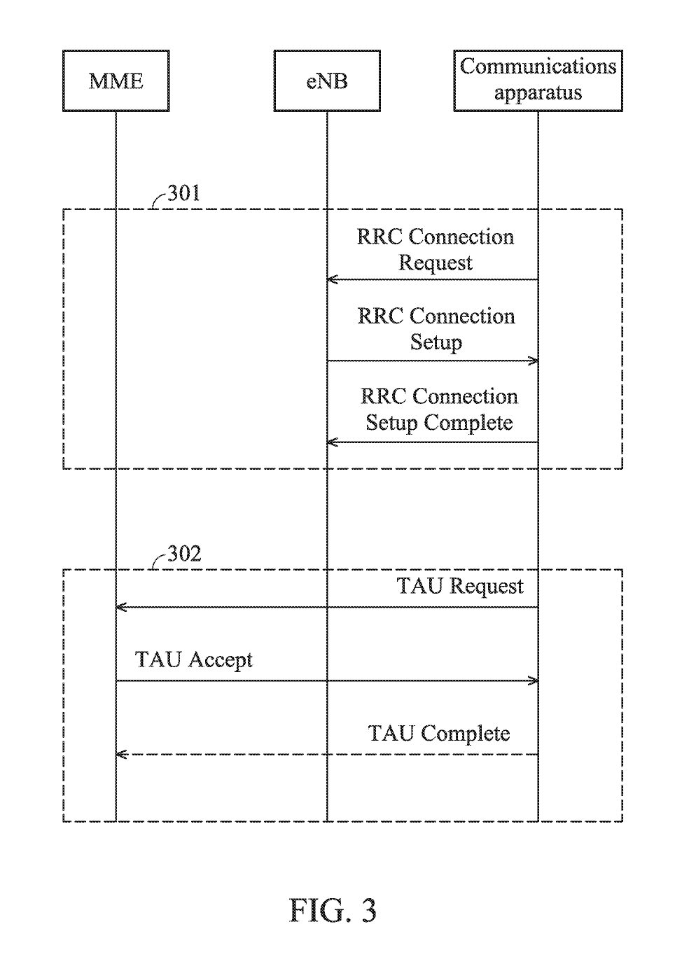

FIG. 3 shows an exemplary message flow of a TAU procedure from the viewpoint of a communications apparatus. In the connection establishment phase 301, the communications apparatus may transmit a connection request message (for example, a radio resource control (RRC) connection request as shown) to the peer device (for example, the eNB as shown) to set up an RRC connection. The peer device in the network may transmit a RRC connection setup message to the communications apparatus in response to the reception of the RRC connection request message. The communications apparatus may set up the RRC connection and then respond with a RRC connection setup complete message to the peer device.

After transmitting the connection setup complete message, a TAU phase 302 is entered, and the communications apparatus may transmit a TAU request message to the peer device (for example, the eNB as shown, and then directed to the Mobility Management Entity (MME) as shown). When the TAU request is accepted, the MME may reply a TAU accept message to the communications apparatus, and the TAU procedure may be successful and completed. Note that the TAU procedure can be successful and completed when receiving the TAU accept message or, the TAU procedure can be successful and completed after the communications apparatus transmitting a TAU complete message, depending on the information carried in the TAU accept message.

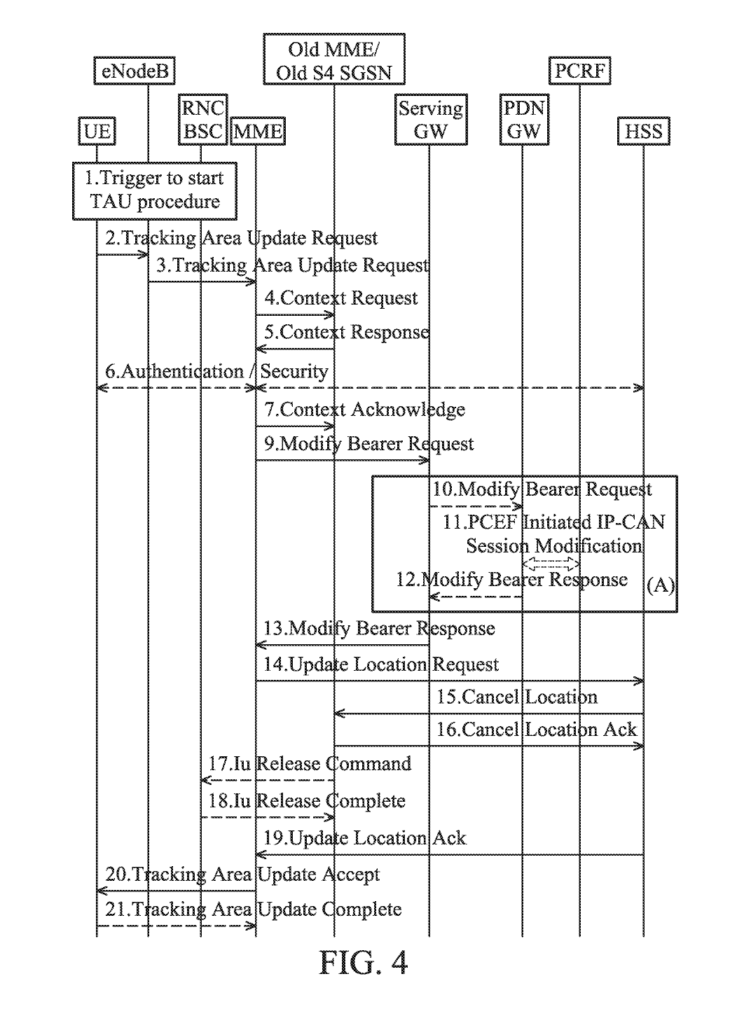

FIG. 4 shows the complete message flow of a TAU procedure in the TAU phase. FIG. 4 shows the standard message flow as defined by the corresponding specification. The TAU procedure is a well-known, well-defined procedure in the art, and the descriptions are omitted here for brevity.

In the corresponding specifications, it is only specified how to handle a paging message after the TAU procedure is completed and the TAU procedure is successful. However, the corresponding specifications fail to specify how to handle a paging message received during the TAU procedure after the TAU procedure has been triggered or received when the TAU procedure fails. In such cases, the communications apparatus cannot trigger a corresponding call setup procedure in response to the receipt of the paging message right away since the communications apparatus has not synchronized its location with the network.

To solve these problems, methods for efficient wireless communications are proposed.

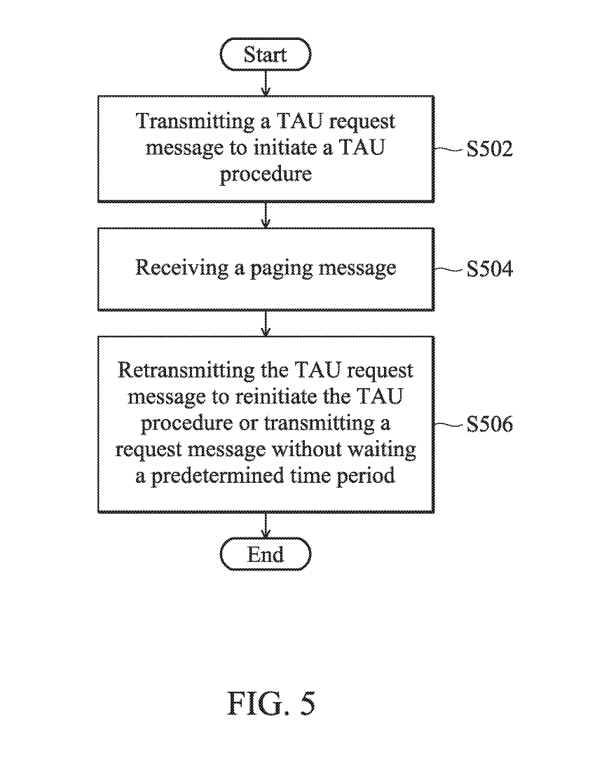

FIG. 5 shows an exemplary flow chart of a method for efficient wireless communications according to an embodiment of the invention. When transmitting a TAU request message to initiate a TAU procedure (Step S502), and receiving a paging message after transmitting the TAU request message (Step S504), the processor of the communications apparatus may retransmit the TAU request message to the peer device to reinitiate the TAU procedure immediately or transmit a request message to the peer device immediately, in response to receipt of the paging message (Step S506), without waiting a predetermined time period.

The predetermined time period may be the time period of a T3411 timer. The T3411 timer is usually started when the TAU procedure fails. As defined by the specification, when the TAU procedure fails, the UE shall start the T3411 timer and wait for the time period (for example, 10 seconds) for the T3411 timer to expire. The UE can reinitiate the TAU procedure only after the T3411 timer has expired.

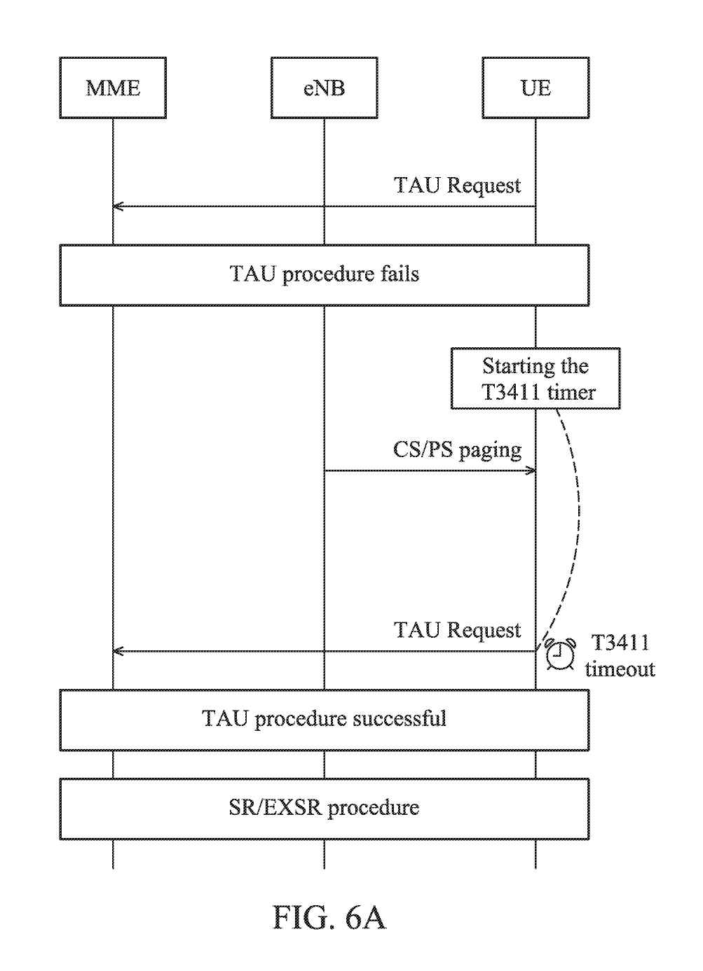

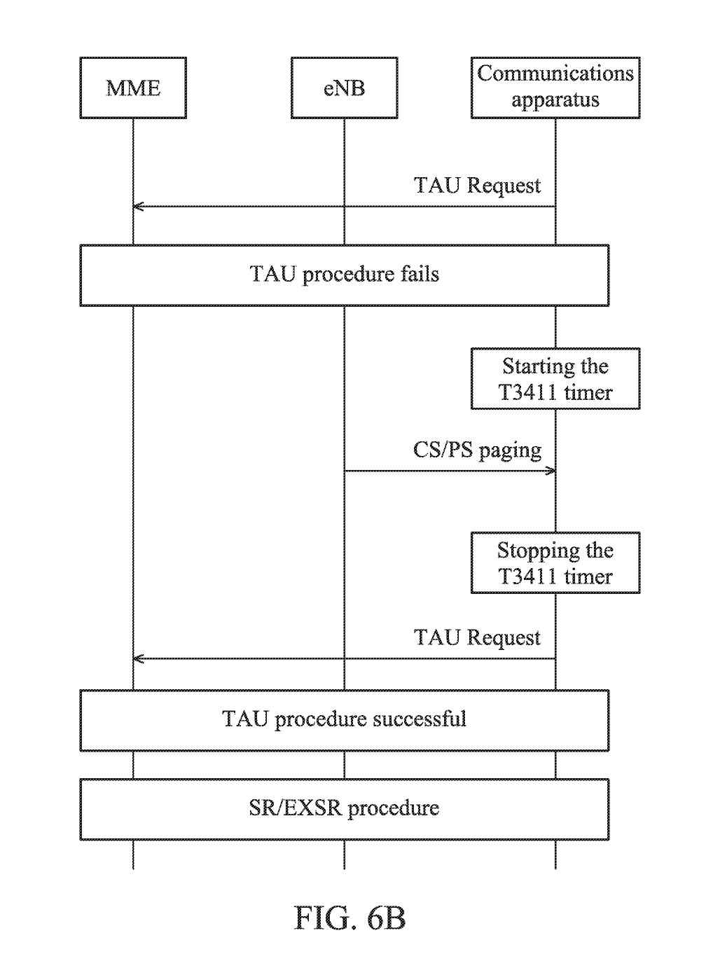

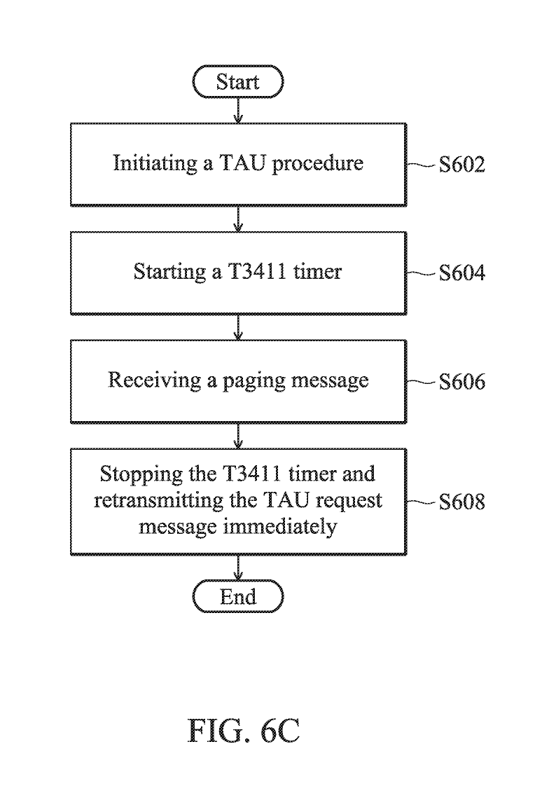

FIG. 6A shows a conventional flow chart for handling a paging message received after the T3411 timer has been started. As shown in FIG. 6A, when the TAU procedure fails, the T3411 timer is started. Even if a paging message is received during the time period before the timer T3411 expires, the UE will not handle it immediately. The UE will transmit the TAU request message again to reinitiate the TAU procedure only after the T3411 timer has expired. When the TAU procedure is successful, the UE will transmit a service request (SR) message or an extended service request (EXSR) message to initiate an SR or EXSR procedure for handling this paging message.

Therefore, conventionally, when a paging message is received as the T3411 timer is still running, the UE has to wait for the expiry of the T3411 timer. Since the UE has to wait for the timer expiry, it will bring about 10 seconds of additional delay time for initiating a call setup procedure.

In order to provide more efficient wireless communications services, according to a first embodiment of the invention, when the paging message is received after the T3411 timer has been started, the processor of the communications apparatus may stop the T3411 timer and retransmit the TAU request message to the peer device, immediately, to reinitiate the TAU procedure right after receiving the paging message.

FIG. 6B shows a flow chart for handling a paging message received after the T3411 timer has been started according to a first embodiment of the invention. In the first embodiment of the invention, when the paging message is received after the T3411 timer has been started, the processor stops the T3411 timer and then retransmits the TAU request message to the peer device to reinitiate the TAU procedure. When the TAU procedure is successful, the processor will transmit a service request (SR) message or an extended service request (EXSR) message to initiate an SR or EXSR procedure for handling this paging message. When the paging message is a circuit-switched (CS) paging message, the processor may transmit an EXSR message to initiate an EXSR procedure for handling this paging message. When the paging message is a packet-switched (PS) paging message, the processor may transmit an SR message to initiate an SR procedure for handling this paging message.

FIG. 6C shows an exemplary flow chart of a method for efficient wireless communications according to the first embodiment of the invention. The processor initiates a TAU procedure when required (Step S602). When the TAU procedure fails, the processor starts a T3411 timer (Step S604). When a paging message is received (Step S606) after the T3411 timer has been started, the processor stops the T3411 timer and retransmits the TAU request message to reinitiate the TAU procedure immediately (Step S608).

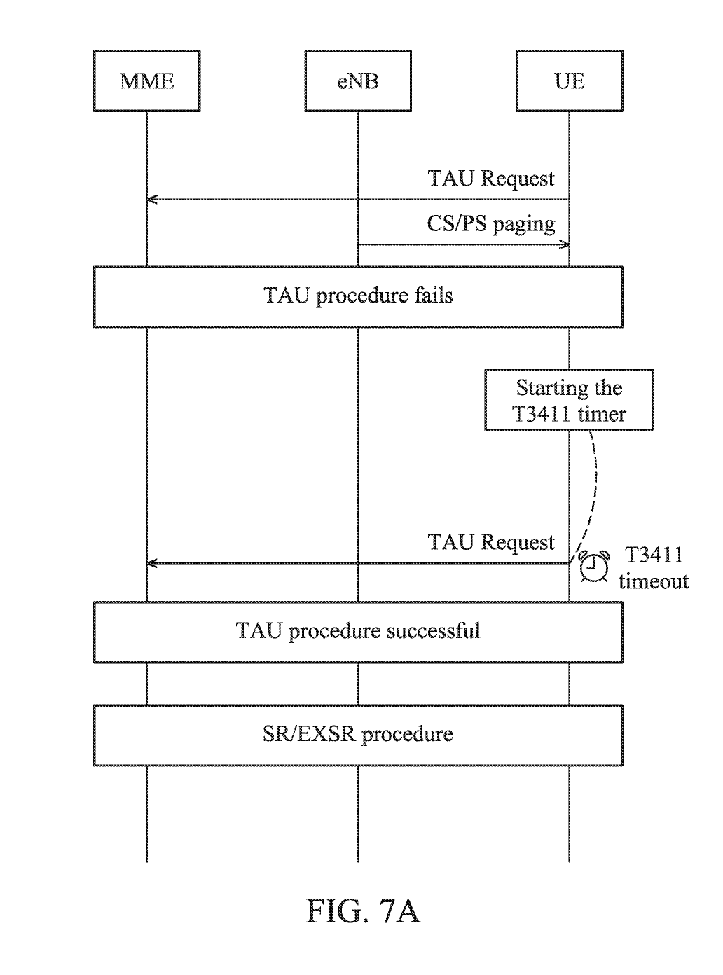

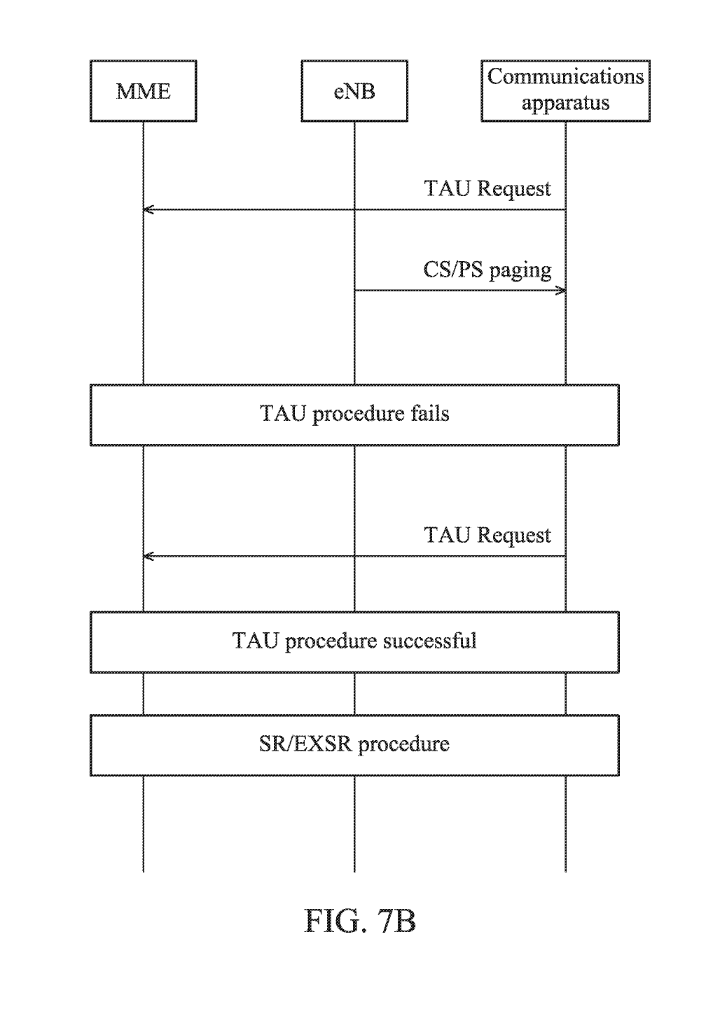

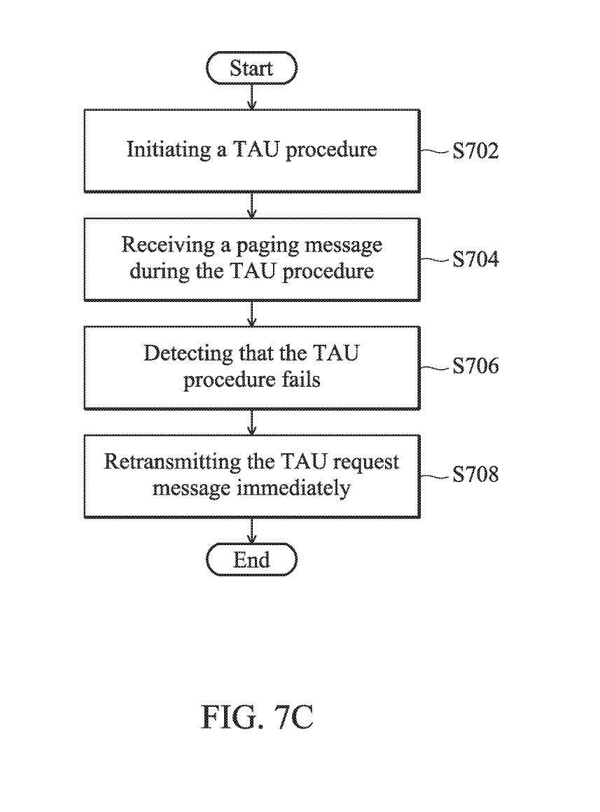

FIG. 7A shows a conventional flow chart for handling a paging message received during the TAU procedure. As shown in FIG. 7A, a paging message is received after the TAU request is transmitted. When the TAU procedure fails, the T3411 timer is started. The UE will transmit the TAU request message again to reinitiate the TAU procedure only after the T3411 timer has expired. When the TAU procedure is successful, the UE will transmit a service request (SR) message or an extended service request (EXSR) message to initiate an SR or EXSR procedure for handling this paging message.

Therefore, conventionally, when a paging message is received during the TAU procedure and the TAU procedure fails, the UE will start the T3411 timer and have to wait for the expiry of the T3411 timer. Since the UE has to wait for the timer expiry, it will bring about 10 seconds of additional delay time for initiating a call setup procedure.

In order to provide more efficient wireless communications services, according to a second embodiment of the invention, when the paging message is received during the TAU procedure and the TAU procedure fails, the processor of the communications apparatus may retransmit the TAU request message to the peer device to reinitiate the TAU procedure immediately without starting the T3411 timer.

FIG. 7B shows a flow chart for handling a paging message received during the TAU procedure according to a second embodiment of the invention. In the second embodiment of the invention, a paging message is received after the TAU request is transmitted. When the TAU procedure fails, the processor may retransmit the TAU request message to the peer device to reinitiate the TAU procedure immediately instead of starting the T3411 timer as defined by the specifications. When the TAU procedure is successful, the processor will transmit a service request (SR) message or an extended service request (EXSR) message to initiate an SR or EXSR procedure for handling this paging message. When the paging message is a circuit-switched (CS) paging message, the processor may transmit an EXSR message to initiate an EXSR procedure for handling this paging message. When the paging message is a packet-switched (PS) paging message, the processor may transmit an SR message to initiate an SR procedure for handling this paging message.

FIG. 7C shows an exemplary flow chart of a method for efficient wireless communications according to the second embodiment of the invention. The processor initiates a TAU procedure when required (Step S702). When a paging message is received during the TAU procedure (Step S704) and the processor then detects that the TAU procedure fails (Step S706), the processor retransmits the TAU request message to reinitiate the TAU procedure immediately (Step S708).

Referring again to FIG. 5, in some embodiments of the invention, the predetermined time period may also be the time period of a T3440 timer. The T3440 timer is usually started when the TAU procedure has succeeded and an active flag was not set (that is, not set to true (i.e. set to false)) during the TAU procedure. As defined by the specification, when an active flag was not set during the TAU procedure, the UE shall start the T3440 timer and wait for the peer device in the network to release the RRC connection. The time period of the T3440 timer is 10 seconds. If the RRC connection is not released by the peer device by the time when the T3440 timer expires, the UE shall perform a local release and return to the IDLE mode.

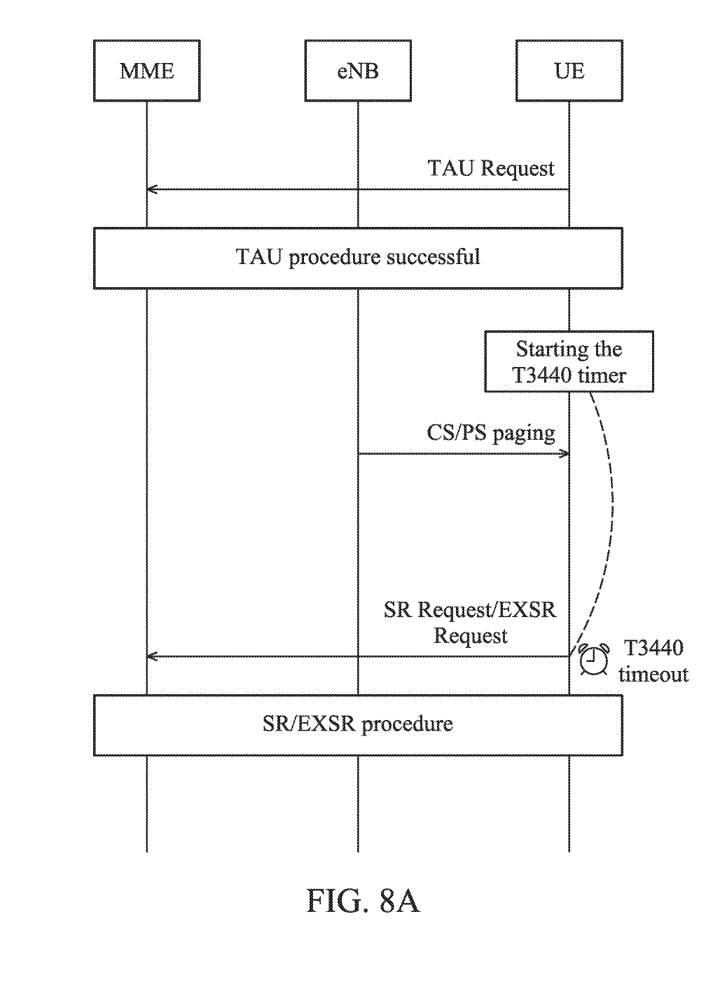

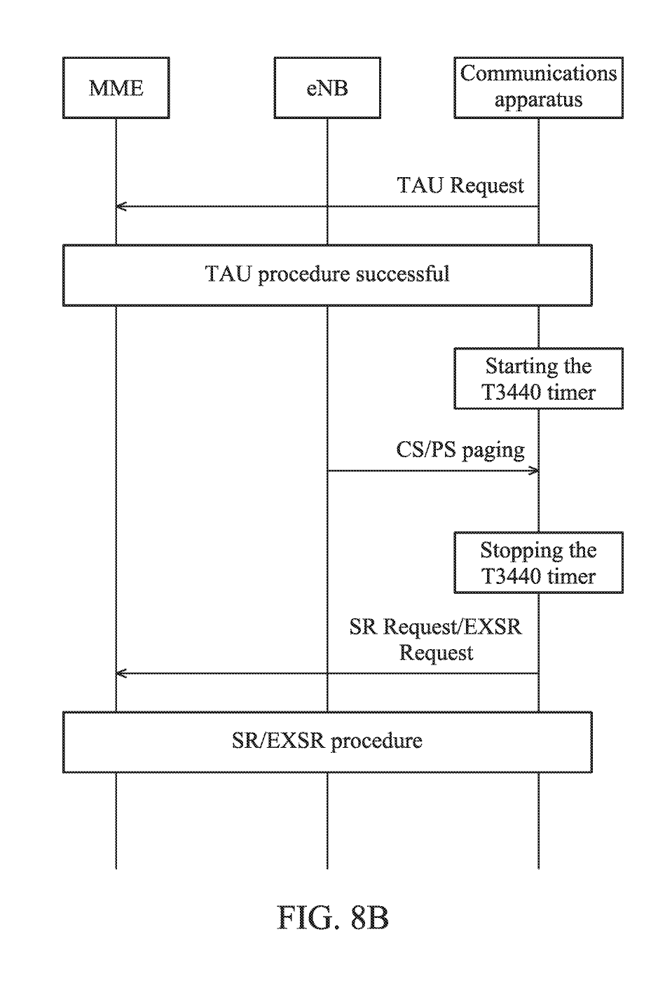

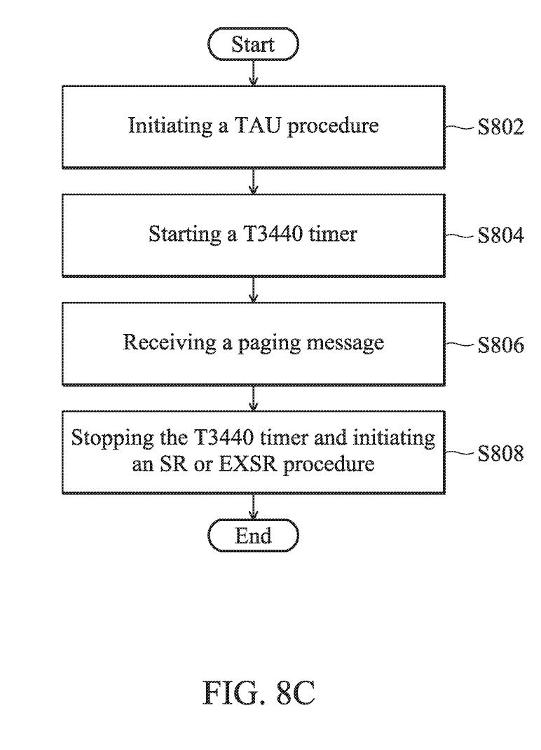

FIG. 8A shows a conventional flow chart for handling a paging message received after the T3440 timer has been started. As shown in FIG. 8A, when the TAU procedure has succeeded and an active flag was not set during the TAU procedure, the UE starts the T3440 timer and wait for the peer device in the network to release the RRC connection. Even if a paging message is received during the time period before the timer T3440 expires, the UE will not handle it immediately. The UE will transmit a service request (SR) message or an extended service request (EXSR) message to initiate an SR or EXSR procedure for handling this paging message after the connection release or after the T3440 timer has expired.

Therefore, conventionally, when a paging message is received after the T3440 timer has been started, the UE has to wait for the expiry of the T3411 timer. Since the UE has to wait for the timer expiry, it will bring about 10 seconds of additional delay time for initiating a call setup procedure.

In order to provide more efficient wireless communications services, according to a third embodiment of the invention, when the paging message is received after the T3440 timer has been started, the processor of the communications apparatus may stop the T3440 timer, perform a local release, and transmit the request message to the peer device right for handling the paging message.

FIG. 8B shows a flow chart for handling a paging message received after the T3440 timer has been started according to a third embodiment of the invention. In the third embodiment of the invention, when the paging message is received after the T3440 timer has been started, the processor stops the T3440 timer, locally releases the current RRC connection, and then transmits a service request (SR) message or an extended service request (EXSR) message to initiate an SR or EXSR procedure for handling this paging message. When the paging message is a circuit-switched (CS) paging message, the processor may transmit an EXSR message to initiate an EXSR procedure for handling this paging message. When the paging message is a packet-switched (PS) paging message, the processor may transmit an SR message to initiate an SR procedure for handling this paging message.

FIG. 8C shows an exemplary flow chart of a method for efficient wireless communications according to the third embodiment of the invention. The processor initiates a TAU procedure and an active flag was not set during the TAU procedure (Step S802). When the TAU procedure is successful, the processor starts a T3440 timer wait for the peer device in the network to release the RRC connection (Step S804). When a paging message is received (Step S806) after the T3440 timer has been started, the processor stops the T3440 timer, locally releases the current RRC connection, and transmits a service request (SR) message or an extended service request (EXSR) message to initiate an SR or EXSR procedure for handling this paging message immediately (Step S808).

By applying the proposed methods discussed above, a TAU procedure or an SR/EXSR procedure can be triggered earlier than with conventional designs, and undesirable delays in triggering call setup procedures can be avoided.

The embodiments of the present invention can be implemented in any of numerous ways. For example, the embodiments may be implemented using hardware, software or a combination thereof. It should be appreciated that any component or collection of components that perform the functions described above can be generically considered as one or more processors that control the function discussed above. The one or more processors can be implemented in numerous ways, such as with dedicated hardware, or with general-purpose hardware that is programmed using microcode or software to perform the functions recited above.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus, comprising:
a radio transceiver, transmitting or receiving wireless radio frequency signals to or from a peer device; and
a processor, transmitting a tracking area update (TAU) request message to the peer device via the radio transceiver to initiate a TAU procedure, receiving a paging message from the peer device after transmitting the TAU request message, and retransmitting the TAU request message to the peer device to reinitiate the TAU procedure immediately or transmitting a request message to the peer device immediately without waiting a predetermined time period.

2. The communications apparatus as claimed in claim 1, wherein the predetermined time period is the time period of a T3411 timer.

3. The communications apparatus as claimed in claim 2, wherein when the paging message is received after the T3411 timer has been started, the processor stops the T3411 timer and retransmits the TAU request message to the peer device to reinitiate the TAU procedure right after receiving the paging message.

4. The communications apparatus as claimed in claim 3, wherein the processor starts the T3411 timer when the TAU procedure fails.

5. The communications apparatus as claimed in claim 2, wherein when the paging message is received during the TAU procedure and the TAU procedure fails, the processor retransmits the TAU request message to the peer device to reinitiate the TAU procedure immediately without starting the T3411 timer.

6. The communications apparatus as claimed in claim 1, wherein the predetermined time period is the time period of a T3440 timer.

7. The communications apparatus as claimed in claim 6, wherein when the paging message is received after the T3440 timer has been started, the processor stops the T3440 timer and transmits the request message to the peer device right after receiving the paging message.

8. The communications apparatus as claimed in claim 6, wherein the processor starts the T3440 timer when the TAU procedure has succeeded and an active flag was not set during the TAU procedure.

9. The communications apparatus as claimed in claim 7, wherein the request message is an extended service request message when the paging message is a circuit-switched (CS) paging message.

10. The communications apparatus as claimed in claim 7, wherein the request message is a service request message when the paging message is a packet-switched (PS) paging message.

11. A method for efficient wireless communications, comprising:
transmitting a tracking area update (TAU) request message by a communications apparatus to a peer device to initiate a TAU procedure;
receiving a paging message by the communications apparatus from the peer device after transmitting the TAU request message; and
in response to receipt of the paging message, retransmitting the TAU request message by the communications apparatus to the peer device to reinitiate communications apparatus to the peer device immediately, without waiting a predetermined time period.

12. The method as claimed in claim 11, wherein the predetermined time period is the time period of a T3411 timer.

13. The method as claimed in claim 11, wherein when the paging message is received after the T3411 timer has been started, the method further comprises:
stopping the T3411 timer and retransmitting the TAU request message to the peer device to reinitiate the TAU procedure right after receiving the paging message.

14. The method as claimed in claim 13, wherein the T3411 timer is started when the TAU procedure fails.

15. The method as claimed in claim 12, wherein when the paging message is received during the TAU procedure and the TAU procedure fails, the method further comprises:
retransmitting the TAU request message to the peer device to reinitiate the TAU procedure immediately without starting the T3411 timer.

16. The method as claimed in claim 11, wherein the predetermined time period is the time period of a T3440 timer.

17. The method as claimed in claim 16, wherein when the paging message is received after the T3440 timer has been started, the method further comprises:
stopping the T3440 timer and transmitting the request message to the peer device right after receiving the paging message.

18. The method as claimed in claim 16, wherein the T3440 timer is started when the TAU procedure has succeeded and an active flag was not set during the TAU procedure.

19. The method as claimed in claim 17, wherein the request message is an extended service request message when the paging message is a circuit-switched (CS) paging message.

20. The method as claimed in claim 17, wherein the request message is a service request message when the paging message is packet-switch (PS) paging message.
